(19) United States
(12) Patent Application Publication
(10) Pub. No.: US 2012/0302385 A1
(43) Pub. Date: Nov. 29, 2012

(54) WELDED SEAM BUSHING

(75) Inventor: Edwin Pawlicki, Morrison, IL (US)

(73) Assignee: Drives, LLC, Fulton, IL (US)

(21) Appl. No.: 13/118,099

(22) Filed: May 27, 2011

(51) Int. Cl. F16G 13/06; B21L 9/04

(52) U.S. Cl. 474/231; 59/4

(57) ABSTRACT

A bushing including a wall having a generally cylindrical configuration with the first and second ends at the outer surface joined to define a continuous outer diameter and the first and second ends at the inner surface disposed adjacent to define a discontinuous inner diameter and a seam that may extend from the inner surface toward the outer surface to an end point along approximately 40-50% of the thickness of the wall.

### FIELD OF THE DISCLOSURE

The present disclosure is related to a bushing, a method of making a bushing and a chain including a bushing, and more particularly, to a welded seam hushing, a method of making a welded seam busing and a chain including a welded seam bushing.

### BACKGROUND

Bus roller chain is a type of chain drive most commonly used for transmission of mechanical power on many kinds of domestic, industrial and agricultural machinery, including conveyors, wire and tube drawing machines, printing presses, cars, motorcycles, and simple machines like bicycles. It consists of a series of short cylindrical rollers held together by side links. It is driven by a toothed wheel called a sprocket, it is a simple, reliable, and efficient means of power transmission. There are two types of links alternating in the bush roller chain. The first type is inner links, having two inner plates held together by two sleeves or bushings upon which two rollers may rotate. Inner links alternate with the second type, the outer links, consisting of two outer plates held together by pins passing through the bushings of the inner links. Conventional bushings have been constructed of solid or tubular materials. The tubular bushings have been machined from solid billets or formed as split seam bushings. The split seam bushings fail at a load rating much lower than the solid or formed tubular bushings. However, the solid and formed tubular bushings use more material, are more expensive, require more machining or assembly step and are heavier.

Therefore, there is a need in the art for a bushing that overcomes the aforementioned disadvantages and provides a higher load rating and lower cost with less material.

### BRIEF DESCRIPTION OF THE DRAWINGS

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

FIG. 1 is a partially cut away top view of a chain including a bushing in accordance with one embodiment of the present disclosure.

FIG. 2 is a top view of a link of the chain of FIG. 1.

FIG. 3 is a side view the link of FIG. 2.

FIG. 4 is an end view of the bushing in accordance with one embodiment of the present disclosure.

FIG. 5 is a top view of the bushing of FIG. 4.

FIG. 6 is a partial section view of the bushing of FIG. 4.

FIG. 7 is a perspective view of a strip of material in accordance with one embodiment of the present disclosure.

FIG. 8 is a perspective view of the strip of material of FIG. 7 after curling.

FIG. 9 is a perspective view of joining first and second ends of an outer surface of the curled strip of material of FIG. 8.

### DETAILED DESCRIPTION

The present disclosure is not limited to the particular details of the apparatus depicted, and other modifications and applications may be contemplated. Further changes may be made in the apparatus, device or methods without departing from the true spirit of the scope of the disclosure herein involved. It is intended, therefore, that the subject matter in this disclosure should be interpreted as illustrative, not in a limiting sense.

In one aspect of the present disclosure, a bushing may include a wall having a generally cylindrical configuration with a first end and a second end and a thickness along each of the first and second ends. The wall may include an outer surface and an inner surface that each extend between the first and second ends. The first and second ends at the outer surface may be joined to define a continuous outer diameter. The first and second ends at the inner surface may be disposed adjacent to define a discontinuous inner diameter and a seam therebetween. The seam may extend from the inner surface toward the outer surface to an end point along approximately 40-50% of the thickness of the wall.

In another aspect of the present disclosure, the first and second ends of the outer surface may be welded without filler material. Additionally, the end point remains ductile after heat treatment. Moreover, the seam may have a width of approximately 0.005 inches to 0.0005 inches at the inner diameter.

In a further aspect of the present disclosure, a chain may include an inner link having a pair of spaced plates connected by a pair of bushings. Each bushing may include a wall having a generally cylindrical configuration with a first end and a second end and a thickness along each of the first and second ends. The wall may include an outer surface and an inner surface that each extend between the first and second ends. The first and second ends at the outer surface may be joined to define a continuous outer diameter. The first and second ends at the inner surface may be disposed adjacent to define a discontinuous inner diameter and a seam therebetween. The seam may extend from the inner surface toward the outer surface to an end point along approximately 40-50% of the thickness of the wall.

In a still further aspect of the present disclosure, the seam may be oriented other than aligned with an axis of loading the chain.

In yet another aspect of the present disclosure, a method of making a bushing may include curling a strip of material into a generally cylindrical configuration, where the strip may include a first end and a second end, a thickness along each of the first and second ends and an outer surface and an inner surface, where each of the outer and inner surfaces may extend between the first and second ends; and joining the first and second ends at the outer surface to an endpoint along approximately 50-60% of the thickness toward the inner surface to define a continuous outer diameter and a discontinuous inner diameter and a seam between the first and second ends of the inner surface at the inner diameter.

In still yet another aspect of the present disclosure, the method may further include heat treating each bushing, such as by carburizing or the like.

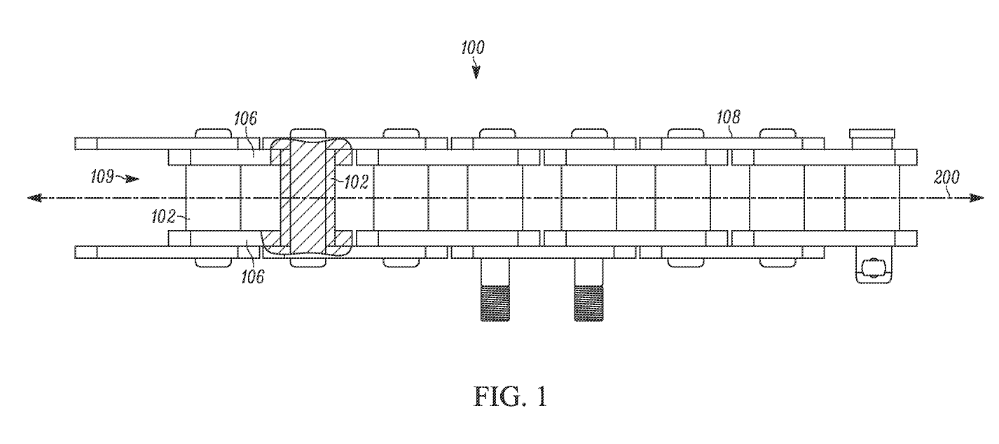

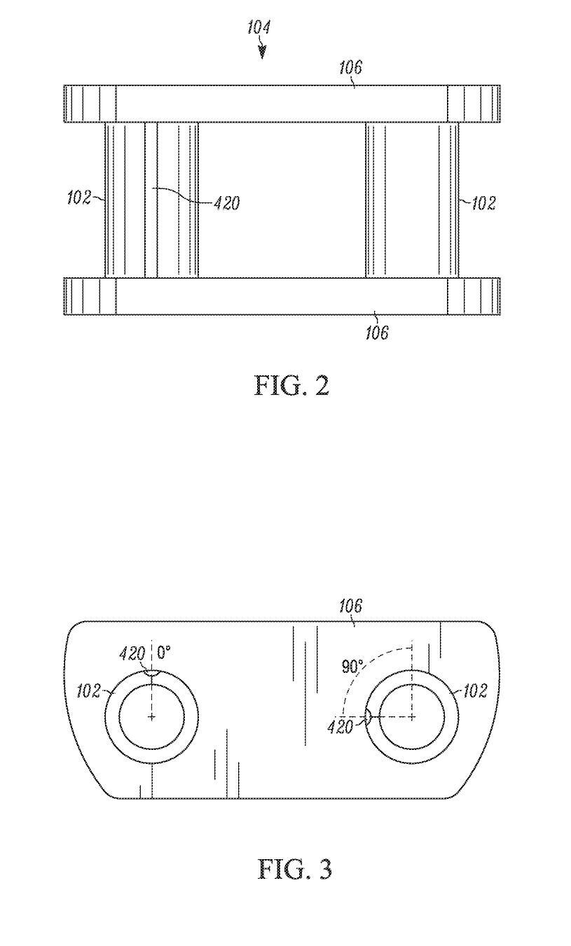

FIG. 1 is a partially cut away top view of a chain 100 including a bushing 102 in accordance with one embodiment of the present disclosure. The chain 100 may include an inner link 104 having a pair of spaced plates 106 connected by a pair of bushings 102. FIG. 2 is a top view of the link 104 of the chain 100 of FIG. 1 wherein the bushings 102 extend between the spaced plates 106. FIG. 3 is a side view the link 104 of FIG. 2. The chain 100 may also include a plurality of inner links 104 and outer links 108 configured, arranged and connected as commonly known to one of skill in the art. A pin 110 (e.g., straight, threaded, cotter, etc.) may be inserted through the bushing 102 to connect the inner links 104 and outer links 108 and/or provide a mounting point for other items, as is known in the art. One of ordinary skill in the art will recognize that an axis of loading 200 of the chain is disposed along its longitudinal axis. It is within the teachings of the present disclosure that the bushing 102 may be oriented at any angular relation with respect to the axis of loading 200 as described below in order to achieve a desired effect, including, without limitation, at 0°, 45°, 90°, 180° with respect to the axis of loading, or any other suitable orientation.

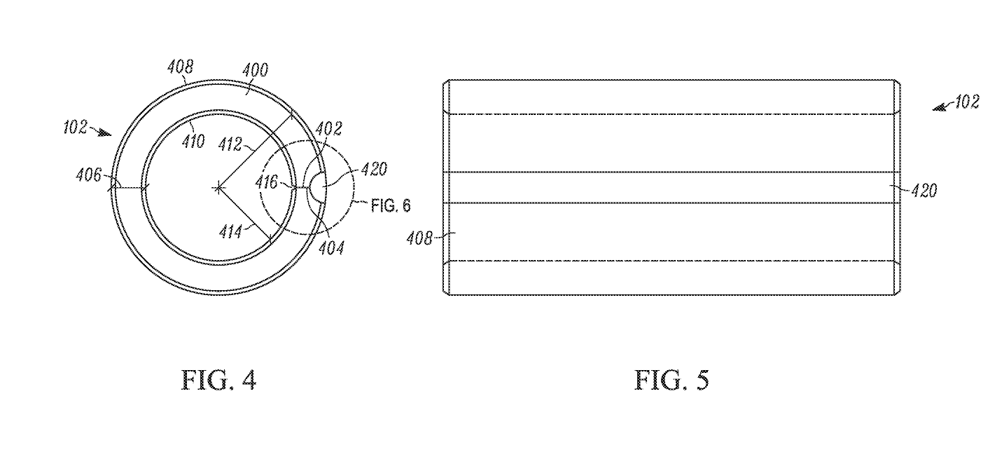

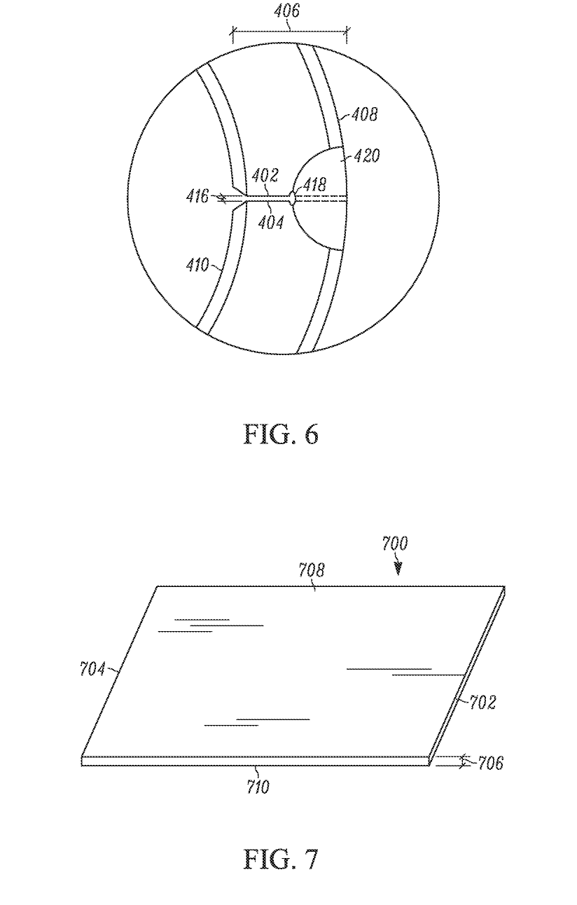

FIG. 4 is an end view of the bushing 102, FIG. 5 is a top view of the bushing 102 of FIG. 4 and FIG. 6 is a partial section view of the bushing 102 of FIG. 4, all in accordance with one embodiment of the present disclosure. The bushing 102 may include a wall 400 having a generally cylindrical configuration with a first end 402 and a second end 404 and a thickness 406 along each of the first and second ends 402, 404. The wall 400 may include an outer surface 408 and an inner surface 410 that each extend between the first and second ends 402, 404. The first and second ends 402, 404 at the outer surface 408 may be joined to define a continuous outer diameter 412 and a joined zone 420. The first and second ends 402, 404 at the inner surface 410 may be disposed adjacent to define a discontinuous inner diameter 414 and a seam 416 therebetween. The seam 416 may extend from the inner surface 410 toward the outer surface 408 to an end point 418 along approximately 40-50% of the thickness 406 of the wall 400. As shown in FIG. 2, the seams 416 may be oriented straight up (i.e., the 0° or 360° orientation if one views the hushing 102 as shown in FIG. 3) which is considered the 0° orientation. Other orientations are within the teachings of the present disclosure, such as, but not limited to 45°, 90° and 180° or any other suitable orientation.

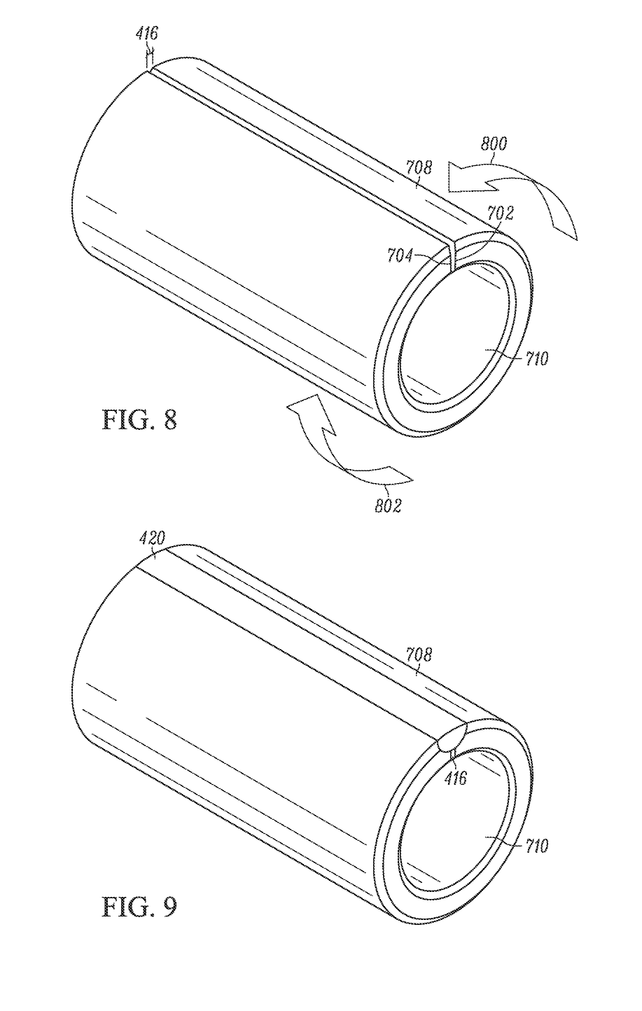

FIG. 7 is a perspective view of a strip of material 700 in accordance with one embodiment of the present disclosure, A method of making a bushing 102 may include curling a strip of material 700 into a generally cylindrical configuration. The strip 700 may include a first end 702 and a second end 704, a thickness 706 along each of the first and second ends 702, 704 and an outer surface 708 and an inner surface 710, where each of the outer and inner surfaces 708, 710 extend between the first and second ends 702, 704. FIG. 8 is a perspective view of the strip of material 700 of FIG. 7 after being formed by a conventional curling process or operation, as indicated by arrows 800, 802.

FIG. 9 is a perspective view of the curled strip of material of FIG. 8 after joining the first and second ends 702, 704 at the outer surface 708 to an endpoint 718 along approximately 50-60% of the thickness 706 toward the inner surface 710 to define a continuous outer diameter 712 and a discontinuous inner diameter 714 and a seam 716 between the first and second ends 702, 704 of the inner surface 710 at the inner diameter 714. The method described herein may further include heat treating each bushing 102 by any suitable process, such as, for example only and not in a limiting manner, carburizing.

Joining may be accomplished, in one embodiment, by welding, coupling otherwise fusing the first and second ends 702, 704 as described above in any suitable manner to define the joined zone 420. For example, a tungsten inert gas welding process may be used without filler material to weld approximately 40-60% of the thickness 706 of the wall 400 or strip of material 700 to define the joined zone 420, or any other suitable process or method.

Heat treating the bushing 102 after joining the first and second ends 702, 704 as described above through hardens the joined portion which is then stronger and more ductile. Additionally, the tight seam 716 created by curling the strip of material 700 prevents the carburizing furnace atmosphere from carburizing the end point 718

Testing on the bushing 102 was performed to validate the effectiveness of the described structure and methods. A first round of testing was performed with bushings 102 in accordance with one embodiment of the present disclosure and solid bushings on Mar. 9, 2011. The bushings were tested in an inner link of a chain to failure (cracking) on a Tinius-Olsen tensile tester, in accordance with standard industry testing practices. The bushings in accordance with the embodiments of the present disclosure were tested with the seam disposed aligned with and other than aligned with an axis of loading as indicated by the “Test at Degrees” column.

Results of Mar. 9, 2011 testing:

| TEST AT DEGREES | POUNDS/IN² TO CRACK |
|---|---|
| 0 | 52,634 |
| 0 | 50,200 |
| 45 | 31,778 |
| 45 | 26,617 |
| 90 | 27,241 |
| 90 | 27,165 |
| 180 | 26,291 |
| 180 | 30,888 |
| Solid | 27,129 |
| Solid | 28,853 |

A second round of testing was performed with bushings 102 in accordance with one embodiment of the present disclosure on Apr. 29, 2011. The bushings were tested in an inner link of a chain to failure (cracking) on a Tinius-Olsen ensile tester, in accordance with standard industry testing practices. The bushings in accordance with the embodiments of the present disclosure were tested with the seam disposed aligned with and other than aligned with an axis of loading as indicated by the “Test at Degrees” column.

Results of Apr. 29, 2011 testing:

| TEST AT DEGREES | POUNDS/IN² TO CRACKING |
|---|---|
| 0 | 46,700 |
| 0 | 47,000 |
| 0 | 42,600 |
| 0 | 49,300 |
| 0 | 39,500 |
| 0 | 40,000 |
| 180 | 22,000 |
| 180 | 23,000 |

One of ordinary skill in the art will recognize that the bushing 102 in accordance with the teachings of the present disclosure is unexpectedly stronger that a solid bushing, despite the fact that both were heat treated together, and also that the joined portion of the bushing 102 is unexpectedly stronger than the wall of the bushing 102.

The preceding detailed description merely sets forth some examples and embodiments of the present disclosure and that numerous changes to the disclosed embodiments can be made in accordance with the disclosure herein without departing from its spirit or scope. The preceding description, therefore, is not meant to limit the scope of the disclosure but to provide sufficient disclosure to one of ordinary skill in the art to practice the invention without undue burden.

What is claimed is:

1. A bushing comprising:
a wall having a generally cylindrical configuration and including a first end and a second end and a thickness along each of the first and second ends;
the wall including an outer surface extending between the first and second ends and an inner surface extending between the first and second ends;
the first and second ends at the outer surface joined to define a continuous outer diameter and the first and second ends at the inner surface disposed adjacent to define a discontinuous inner diameter and a seam therebetween;
the seam extending from the inner surface toward the outer surface to an end point along approximately 40-50% of the thickness of the wall.

2. A hushing as described in claim 1, wherein the first and second ends of the outer surface are welded without filler material.

3. A bushing as described in claim 1, wherein the end point remains ductile after heat treatment.

4. A bushing as described in claim 1, wherein the seam has a width of approximately 0.001 inches at the inner diameter.

5. A chain comprising:
an inner link including a pair of spaced plates connected by a pair of bushings, wherein each bushing includes
a wall having a generally cylindrical configuration and including a first end and a second end and a thickness along each of the first and second ends;
the wall including an outer surface extending between the first and second ends and an inner surface extending between the first and second ends;
the first and second ends at the outer surface joined to define a continuous outer diameter and the first and second ends at the inner surface disposed adjacent to define a discontinuous inner diameter and a seam therebetween;
the seam extending from the inner surface toward the outer surface to an end point along approximately 40-50% of the thickness of the wall.

6. A chain as described in claim 1, wherein the first and second ends of the outer surface are welded without filler material.

7. A chain as described in claim 1, wherein the end point remains ductile after heat treatment.

8. A chain as described in claim 1, wherein the seam has a width of approximately 0.001 inches at the inner diameter.

9. A chain as described in claim 5, wherein the seam is oriented other than aligned with an axis of loading the chain.

10. A method of making a bushing comprising:
curling a strip of material into a generally cylindrical configuration, the strip including a first end and a second end, a thickness along each of the first and second ends and an outer surface and an inner surface, each of the outer and inner surfaces extending between the first and second ends; and
joining the first and second ends at the outer surface to an endpoint along approximately 50-60% of the thickness toward the inner surface to define a continuous outer diameter and a discontinuous inner diameter and a seam between the first and second ends of the inner surface at the inner diameter.

11. A method of making a bushing as described in claim 10, further comprising heat treating each hushing.

12. A method of making a hushing as described in claim 11, wherein heat treating includes carburizing.
